(19) United States
(12) Patent Application Publication
(10) Pub. No.: US 2015/0062703 A1
(43) Pub. Date: Mar. 5, 2015

(54) STRENGTHENED PLATE FOR TOUCH DEVICE

(71) Applicant: Jiou Yi Technology Co., Ltd., New Taipei City (TW)

(72) Inventor: Bo-Yan Chen, New Taipei City (TW)

(73) Assignee: Jiou Yi Technology Co., Ltd., New Taipei City (TW)

(21) Appl. No.: 14/011,429

(22) Filed: Aug. 27, 2013

(51) Int. Cl. G02B 27/00

(52) U.S. Cl. CPC G02B 27/0006
USPC 359/507

(57) ABSTRACT

A protective plate adapted for portable touch device with a touch screen includes a transparent plate; an opaque layer printed on a peripheral surface of the transparent plate and having an opening defined therethrough; and an adhesive layer printed on a free surface of the opaque layer and able to be selectively pasted on the touch screen to prevent from pollution.

### BACKGROUND OF THE INVENTION

1. Field of the Invention

This invention is related to a plate for protection of touch devices (such as mobile phone and tablet) from being scratched, and more particular to a reusable plate able to be pasted on the touch interface of the touch device and replacable without causing any damage to the structure of the contact face thereof.

2. Description of the Related Art

As the technology becomes more advanced, the function of touch operation is progressively introduced into portable devices, such as the touch screen of mobile phone and tablet PC, and is able to replace the conventional operating buttons to be more convenient for users to operate. Because of that, the screen size of the portable device is able to be designed largely to present more information to users.

After frequently touching the screen, scars may be possibly formed by something sharp or hard. To avoid that, a protective film is used to paste on the entire screen with adhesive therebetween. However, how to paste the protective film on the screen of the portable device is inconvenient to the user. Because, during the pasting process, air may be carelessly remained and sealed between the protective film and the screen, which may influence the appearance of the screen or even cause the protective film departed from the screen after using a period of time. Still another, the protective film is not strong enough and is possible to be corrupted through frequently rubbing, and thus replacement of the protective film is needed to maintain protection of the screen.

### SUMMARY OF THE INVENTION

The primary purpose of the present invention is to provide a durable protective plate for protection of portable touch devices especially with enhanced structure and less contact to the touch screen, and furthermore the protective plate is able to be designed as different colors and is conveniently replacable to change appearance of the portable touch devices depending on the user's desire.

In order to accomplish the aforementioned purpose, the protective plate constructed in accordance the present invention includes a transparent plate; an opaque layer printed on a peripheral surface of the transparent plate and having an opening defined therethrough; and an adhesive layer printed on a free surface of the opaque layer and able to be selectively pasted on the touch screen to prevent from pollution.

### BRIEF DESCRIPTION OF THE DRAWINGS

The invention, as well as its many advantages, may be further understood by the following detailed description and drawings in which:

FIG. 1 is an exploded, perspective view of the protective plate constructed in accordance with the present invention; and

FIG. 2 is a schematic cross-sectional view showing the layers of the protective plate constructed in accordance with the present invention.

### DETAILED DESCRIPTION OF THE INVENTION

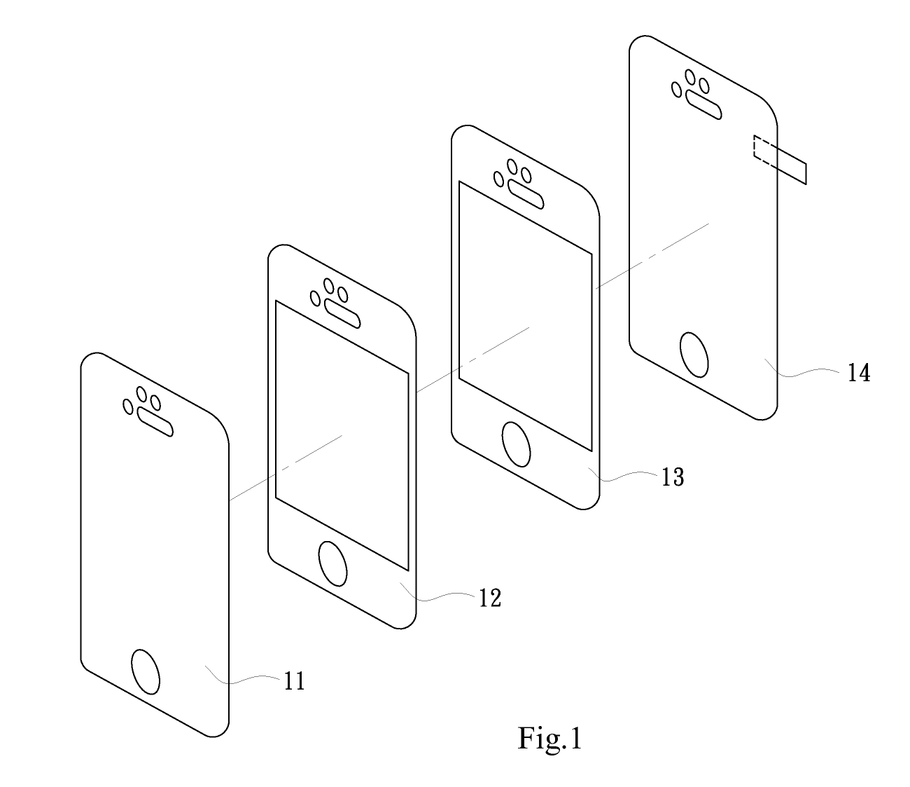

With reference to FIG. 1, a protective plate constructed in accordance with the preferred embodiment of the present invention includes a plate 11, a printed layer 12 formed on a side face of the plate 11, an adhesive layer 13 formed on a free surface of the printed layer 12.

The plate 11 is a material of glass with thickness of 0.3-2.0 mm and cut to be matched with the size of a touch device (not shown). It is to be noticed that, in this preferred embodiment of the invention, the plate 11 is cut to adapt to a mobile phone having a touch screen, and the plate 11 has openings (not numbered) defined therethrough to correspond to equipment such as speaker, camera, illuminator and etc.

The printed layer 12 is printed on a peripheral face of the plate 11 by screen printing, pad printing or roll printing which are conventional in the art, and the printed layer 12 relatively has openings (not numbered) defined therethrough to correspond to the openings of the plate 11 and further has a screen opening defined therethrough to correspond to the touch screen of the mobile phone. As the said printing techniques are well known in the art, a pigment or pigments to the printed layer 12 is selective in accordance with the purpose of design.

The adhesive layer 13 is securely pasted on a free surface of the printed layer 12 by a conventional process such as printing. In this preferred embodiment of the present invention, the category of the adhesive layer 13 is selected from a group consisted of hydrogel, optical clear adhesive and viscoelastic adhesive.

Furthermore, an isolated layer 14 is selected to be pasted on a free surface of the adhesive layer 13 in order to prevent the adhesive layer 13 from pollution by dust which may influence the viscosity thereof.

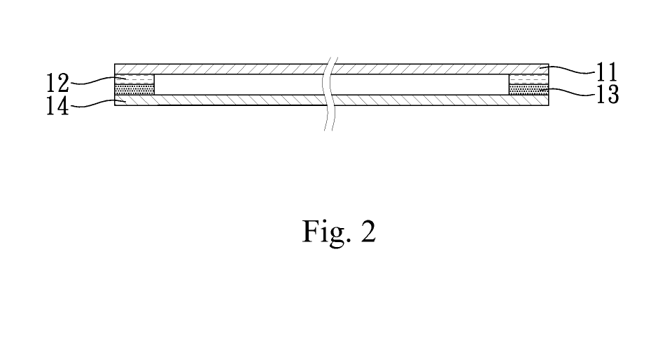

With reference to FIG. 2, a schematic cross-sectional view shows the structure of the protective plate having a space defined therein due to configuration of the screen opening of the printed layer 12. The isolated layer 14 is able to be removed to allow interface contact between the adhesive layer 13 and the touch screen of the mobile phone, and then the protective plate is able to paste on the touch screen, and information from the touch screen is able to be seen through a window defined by the screen opening of the printed layer 12. Since the printed layer 12 and the adhesive layer 13 are relatively thin to the plate 11, which means the plate 11 is adjacent to the touch screen while the protective plate is applied to the mobile phone. Such that, the touch screen is still sensitive to objects sliding on the plate 11.

In order to enhance the plate 11, a treatment like plating is selectively applied to a free surface of the plate 11 to enhance optical transmittance from the screen and abilities of anti-fingerprint or glare.

Convenient to replacement, the protective plate is able to be removed from the touch screen without damaging the adhesive layer 13 and meanwhile keeping clear to the touch screen. Accordingly, the protective plate is able to be reused or substituted for another.

Many changes and modifications in the above described embodiment of the invention are able to, of course, be carried out without departing from the scope thereof. Accordingly, to promote the progress in science and the useful arts, the invention is disclosed and is intended to be limited only by the scope of the invention.

What is claimed is:

1. A protective plate adapted to a portable touch device having a touch screen, comprising:
a transparent plate;
an opaque layer printed on a peripheral surface of the transparent plate and having an opening defined therethrough to be a window for the touch screen; and
an adhesive layer printed on a free surface of the opaque layer and able to be alternatively pasted on the touch screen to be covered to avoid pollution and scratches.

2. The protective plate as claimed in claim 2, wherein the thickness of the transparent plate is in the range of 0.3-2.0 mm.

3. The protective plate as claimed in claim 3, wherein the adhesive layer is selected from a group consisted of hydrogel, optical clear adhesive and viscoelastic adhesive.
